(19) United States
(12) Patent Application Publication
(10) Pub. No.: US 2026/0046032 A1
(43) Pub. Date: Feb. 12, 2026

(54) SIGNAL PROCESSING DEVICE AND SIGNAL PROCESSING METHOD

(71) Applicant: Fujitsu Limited, Kawasaki-shi (JP)

(72) Inventors: Junichi SUGIYAMA, Kawasaki (JP); Atsushi KANAI, Kawasaki (JP); Ichiro YOKOKURA, Sano (JP)

(73) Assignee: Fujitsu Limited, Kawasaki-shi (JP)

(21) Appl. No.: 19/361,368

(22) Filed: Oct. 17, 2025

Related U.S. Application Data
(63) Continuation of application No. PCT/JP2024/010114, filed on Mar. 14, 2024.

(30) Foreign Application Priority Data
Apr. 21, 2023 (JP) 2023-070245

(51) Int. Cl. H04B 10/524; H04L 5/00

(52) U.S. Cl. CPC H04B 10/524; H04L 5/0048

(57) ABSTRACT

A signal processing device is connected to an optical transmitter that transmits an Ethernet signal by optical modulation based on a data signal. The signal processing device includes a mapper unit configured to map a plurality of client signals into a frame signal, an encoder configured to encode the frame signal to generate blocks of a number of bits corresponding to the Ethernet signal, and a signal outputter configured to generate the data signal from the blocks and outputs the data signal to the optical transmitter.

### CROSS-REFERENCE TO RELATED APPLICATION

This application is a continuation application of PCT/JP2024/010114 filed on Mar. 14, 2024, which claims priority to Japanese Patent Application No. 2023-070245 filed on Apr. 21, 2023, the contents of which are herein wholly incorporated by reference.

### FIELD

A certain aspect of the present embodiments relates to a signal processing device and a signal processing method.

### BACKGROUND

For example, there is described a technology for bundling client signals from multiple lines into a FlexE group, multiplexing them into an OTN (Optical Transport Network) frame, and transmitting them over an optical transport network (see, Japanese Patent Application Publication No. 2018-85653). Optical modules capable of transmitting such OTN-frame optical signals include, for example, detachable CFP (Centum gigabit Form-factor Pluggable) 2-DCO (Digital Coherent Optics) and on-board DCO.

However, telecom carriers and data center operators may prefer less expensive optical modules, even if they offer lower performance than the above-mentioned optical modules. Examples of such optical modules include QSFP (Quad Small Form-factor Pluggable)-DD (Double Density), which can transmit Ethernet (registered trademark; the same applies hereinafter). OTN is defined in ITU-T (International Telecommunication Union Telecommunication Standardization Sector) Recommendation G.709. They may prefer less expensive optical modules, even if they offer lower performance than the above-mentioned modules. An example of such an optical module is a Quad Small Form-factor Pluggable (QSFP)-Double Density (DD) module that can transmit Ethernet (registered trademark, the same applies hereinafter). Note that OTN is defined in ITU-T (International Telecommunication Union Telecommunication Standardization Sector) Recommendation G.709.

### SUMMARY

According to an aspect of the present disclosure, there is provided a signal processing device connected to an optical transmitter that transmits an Ethernet signal by optical modulation based on a data signal, including: a mapper unit configured to map a plurality of client signals into a frame signal; an encoder configured to encode the frame signal to generate blocks of a number of bits corresponding to the Ethernet signal; and a signal outputter configured to generate the data signal from the blocks and outputs the data signal to the optical transmitter.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a configuration diagram of an example of a transmission system according to a first embodiment.

FIG. 2 is a diagram of an example of a client signal processing.

FIG. 3 is a diagram of an example of data rate adjustment.

FIG. 4 is a configuration diagram of an example of a transmission system according to a second embodiment.

FIG. 5 is a diagram of an example of a GMP (Generic Mapping Procedure) frame.

FIG. 6 is a flowchart of an example of an operation of a transmission processor.

FIG. 7 is a flowchart showing an example of the operation of a reception processing unit.

### DESCRIPTION OF EMBODIMENTS

Because the QSFP-DD specification requires that not only the output optical interface but also the input electrical interface conform to Ethernet, it is difficult to transmit other types of client signals, such as an OTN frame, in an Ethernet signal on the optical side. In contrast, if the client signal is encapsulated in an Ethernet-compliant packet, it can be transmitted in an Ethernet signal.

However, in order to properly perform complex and high-load processing such as generating the destination address, source address, and FCS (Frame Check Sequence) in the packet, it is necessary to implement a large-scale circuit, such as a circuit emulator, in the transmitter.

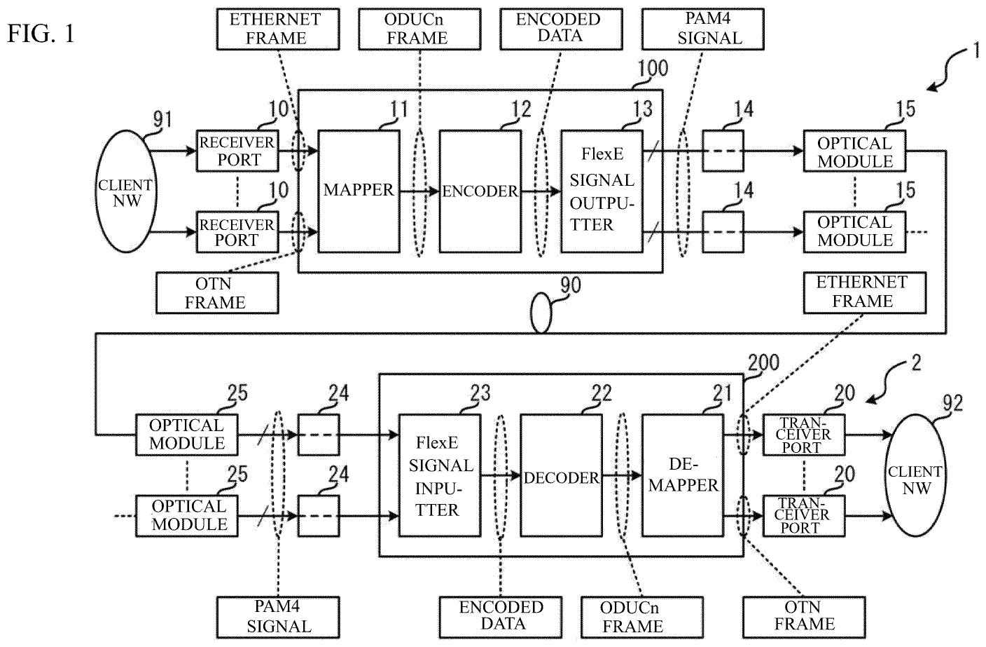

(First Embodiment) FIG. 1 is a configuration diagram of an example of a transmission system according to the first embodiment. The transmission system is used, for example, for communications between data centers, and includes a transmitter 1 and a receiver 2 connected to each other via a transmission path 90 such as an optical fiber. The transmitter 1 transmits an Ethernet signal to the receiver 2. The transmission rate of the Ethernet signal is, for example, 400 Gbps, and the transmission method complies with, for example, IEEE (Institute of Electrical and Electronics Engineers) 802.3bs.

The transmitter 1 includes multiple receiver ports 10, a transmission processor 100, multiple electrical connectors 14, and multiple optical modules 15. The optical module 15 is an example of an optical transmitter, for example, a QSFP-DD. The optical module 15 is detachably connected to the electrical connector 14. The pin arrangement of the electrical connector 14 complies with the QSFP-DD standard. The optical module 15 is connected to the transmission processor 100 via the electrical connector 14.

The receiver port 10 receives various client signals from a client network (NW) 91. Examples of frame formats for client signals include, but are not limited to, Ethernet frame and OTN frame. The receiver port 10 outputs the received client signals to the transmission processor 100.

The transmission processor 100 is an example of a signal processing device, and is implemented by hardware such as an FPGA (Field Programmable Gate Array) or an ASIC (Application Specified Integrated Circuit). The transmission processor 100 includes a mapper 11, an encoder 12, and a FlexE signal outputter 13. The transmission processor 100 is connected to an optical module 15 via an electrical connector 14. Note that the operation of the transmission processor 100 described below is an example of a signal processing method.

The mapper 11 maps multiple client signals into a frame signal. The frame signal format is not limited, but in this embodiment, the format is based on ITU-T Recommendation G. An example is an ODUCn frame defined in ITU-T Recommendation G.709.

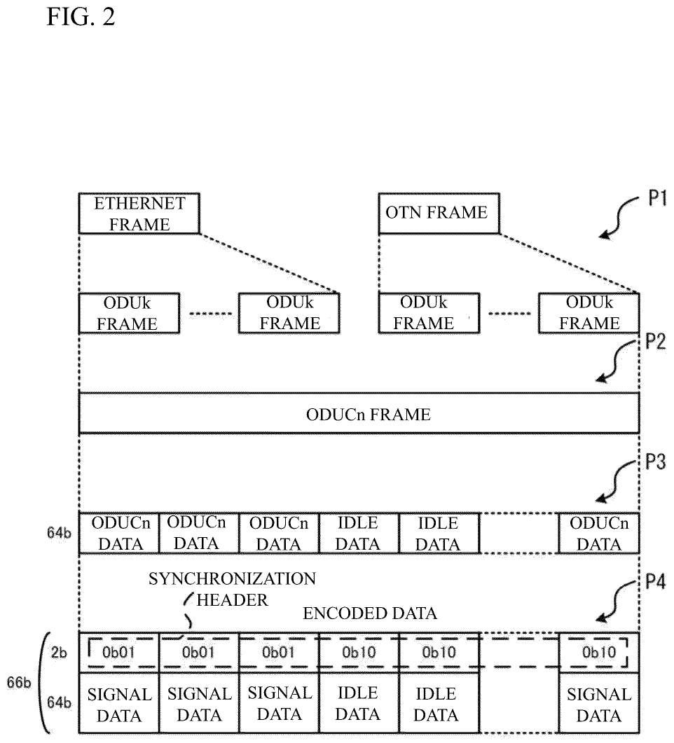

FIG. 2 is a diagram illustrating an example of client signal processing. For example, the mapper 11 first accommodates the Ethernet frame and the OTN frame of the client signal in an ODUk frame (see symbol P1). The mapper 11 then accommodates each ODUk frame in an ODUCn frame (see symbol P2). Here, the ODUk is a data accommodation unit defined in ITU-T Recommendation G.709. For example, the mapper 11 maps each ODUk frame to an ODUCn frame using the sigma-delta distribution method of GMP defined in ITU-T Recommendation G.709.

Furthermore, the mapper 11 adds IDLE data of a predetermined pattern to the ODUCn frame depending on the difference between the transmission rate of the Ethernet signal from the optical module 15 and the data rate of the ODUCn frame (see symbol P3). At this time, the mapper 11 adds IDLE data of a data amount that minimizes the difference. In other words, the mapper 11 performs padding on the ODUCn frame.

Therefore, the mapper 11 can convert the data rate of the ODUCn frame according to the transmission rate of the Ethernet signal transmitted by the optical module 15. Furthermore, the standard deviation of the ODUCn frame rate (±20 ppm) and the standard deviation of the Flex frame rate in the FlexE signal outputter 13 (±100 ppm) are satisfied. Note that IDLE data is an example of dummy data.

The mapper 11 outputs the ODUCn frame to the encoder 12. At this time, the mapper 11 divides the ODUCn frame into blocks of 64 bits each and notifies the encoder 12 whether the block is signal data or IDLE data.

The encoder 12 encodes the frame signal to generate blocks of bits each corresponding to the Ethernet signal transmitted by the optical module 15. In this embodiment, because the optical module 15 is a QSFP-DD, the encoder 12 performs 64B/66B encoding on the signal data of the ODUCn frame. As a result, the signal data of the ODUCn frame is encoded into 66-bit data blocks, 64 bits at a time.

The encoder 12 scrambles the signal data of the ODUCn frame in 64-bit units and adds a 2-bit synchronization header to the scrambled 64-bit data. The value of the synchronization header is “10” (binary) for IDLE data and “01” (binary) for signal data (see symbol P4). The encoder 12 determines the value of the synchronization header based on a notification from the mapper 11.

In this way, the 66-bit block of encoded data (hereinafter referred to as encoded data) includes a synchronization header that identifies the IDLE data and the signal data, respectively. This allows the receiver 2 to easily distinguish between the IDLE data and the signal data based on the synchronization header.

The FlexE signal outputter 13 generates a FlexE frame from a 66-bit block of encoded data and outputs it to the optical module 15. The FlexE signal outputter 13 has a FlexE shim function defined by the Optical Interworking Forum (OIF). The FlexE signal outputter 13 generates a FlexE frame by treating the encoded data as a FlexE client, accommodating the encoded data in multiple calendar slots based on calendar information, and adding Flex overhead. At this time, the FlexE signal outputter 13 may divide the encoded data into multiple FlexE frames and output them to the separate optical modules 15.

The FlexE signal outputter 13 has a physical layer PMA (Physical Media Attachment) function. The FlexE signal outputter 13 modulates the FlexE frame with pulse amplifier modulation (PAM) to convert it into multiple PAM4 signals. The FlexE signal outputter 13 outputs the signals in parallel from the SerDes circuit to the optical module 15. Note that the FlexE signal outputter 13 is an example of a signal outputter, and the PAM4 signal is an example of a data signal.

The optical module 15 generates an Ethernet signal by optically modulating the transmitted light based on the PAM4 signal. The Ethernet signal is transmitted through the transmission path 90 and input to the receiver 2.

The receiver 2 has multiple transmission ports 20, a reception processor 200, an electrical connector 24, and an optical module 25. The optical module 25 is an example of an optical receiver, such as a QSFP-DD. The optical module 25 receives the Ethernet signal. The optical module 25 converts the light of the Ethernet signal into an electrical signal using a photodiode and outputs the electrical signal as multiple PAM4 signals to the reception processor 200.

The reception processor 200 is an example of a signal processing device and is realized by hardware such as an FPGA or ASIC. The reception processor 200 includes a demapper 21, a decoder 22, and a FlexE signal inputter 23. The reception processor 200 is connected to the optical module 25 via the electrical connector 24. Note that the operation of the reception processor 200 described below is an example of a signal processing method.

The PAM4 signal is input to the FlexE signal inputter 23 via the electrical connector 24. The FlexE signal inputter 23 has a FlexE shim function defined by the OIF. The FlexE signal inputter 23 recovers a FlexE frame from the PAM4 signal and extracts coded data from the FlexE frame based on calendar information. The coded data is input to a decoder.

The decoder 22 decodes the 64B/66B coded data. The decoder 22 removes the 2-bit synchronization header from each 66-bit block of coded data and recovers the signal data of the ODUCn frame from the remaining 64-bit block. At this time, the decoder 22 distinguishes between signal data and IDLE data based on the value of the synchronization header. If the synchronization header is “10” (binary), the decoder 22 identifies and discards IDLE data, and if the synchronization header is “01” (binary), the decoder 22 identifies and descrambles the signal data. The decoder 22 outputs the ODUCn frame to the demapper 21.

The demapper 21 demaps multiple client signals from the ODUCn frame. Demapping is performed in accordance with the above-mentioned GMP. The demapper 21 demaps Ethernet frame and OTN frame from the ODUCn frame and outputs them to individual transmission ports 20. The transmission ports 20 transmit the Ethernet frame and OTN frame to a client network 92.

In this way, the transmission processor 100 maps multiple client signals to a common ODUCn frame and performs 64B/66B encoding on the ODUCn frame to generate 66-bit blocks corresponding to the Ethernet signal of the optical module 15. Therefore, the transmission processor 100 does not need to packetize client signals using expensive devices such as a circuit emulator, and can transmit multiple types of client signals in an Ethernet signal using a low-cost configuration. While 64B/66B encoding is used in this example, 8B/10B encoding may be used depending on the type of Ethernet signal.

The reception processor 200 also decodes the FlexE frame output from the optical module 25 that received the Ethernet signal, and demaps multiple client signals from the encoded data. Therefore, the reception processor 200 can receive multiple client signals from the Ethernet signal transmitted by the transmitter 1.

Furthermore, when the FlexE signal outputter 13 and the FlexE signal inputter 23 operate on clock systems different from those of the encoder 12 and the decoder 22, respectively, the FlexE signal outputter 13 and the FlexE signal inputter 23 adjust the data rate by inserting or removing IDLE data. However, even if the number of IDLE data bits increases or decreases in the FlexE signal inputter 23, the decoder 22 can identify the signal data using the synchronization header, and therefore can reproduce the ODUCn frame without any problems.

In this example, ODUCn frame is used as a frame signal accommodating a client signal, and the data rate of the ODUCn frame varies depending on the value of n (a positive integer). Therefore, the difference between the transmission rate of the Ethernet signal transmitted by the optical module 15 and the data rate of the ODUCn frames also varies depending on the value of n (a positive integer). Therefore, the mapper 11 may adjust the data rate of the ODUCn frame depending on the transmission rate of the Ethernet signal.

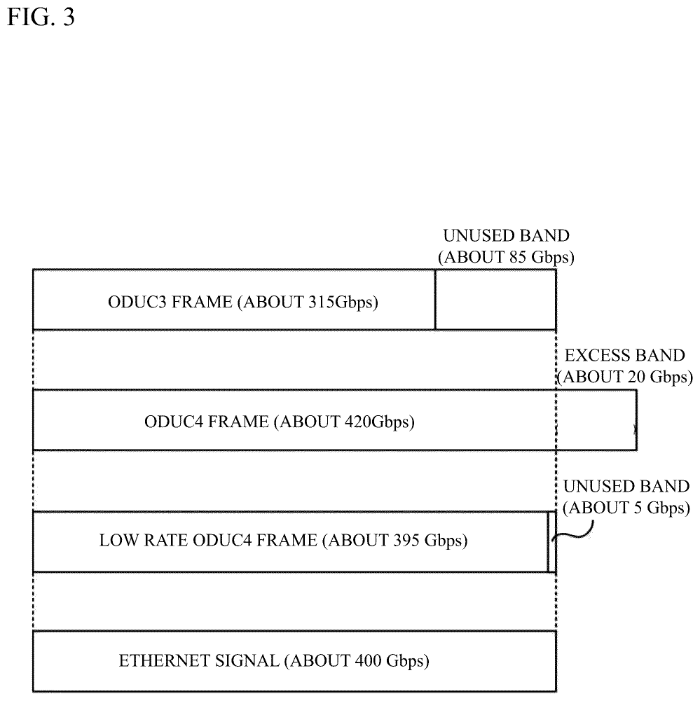

FIG. 3 is a diagram of an example of data rate adjustment. The data rate of ODUCn frame is approximately (n×105.3) (Gbps). Therefore, when ODUC3 frame (n=3) is used, the data rate is approximately 315 (Gbps), which is 85 (bps) less than the 400 (Gbps) transmission rate of the Ethernet signal. This difference represents the unused bandwidth of the Ethernet signal.

Furthermore, when ODUC4 frame (n=4) is used, the data rate is approximately 420 (Gbps), which exceeds the 400 (Gbps) transmission rate of the Ethernet signal by approximately 20 (Gbps). Therefore, the mapper 11 adjusts the data rate of the ODUC4 frame by reducing it by approximately 6% to approximately 395 (Gbps). As a result, the unused bandwidth of the ODUC4 frame (low rate) with a reduced data rate is approximately 5 (Gbps), which is 80 (Gbps) less than that of a normal ODUCn frame. This increases the bandwidth utilization efficiency of the Ethernet signal.

(Second Embodiment) In the first embodiment, the client signal is accommodated in an ODUCn frame, but this is not limited to this. In the second embodiment, a frame in which the client signal data and IDLE data are mapped using GMP (hereinafter referred to as a GMP frame) is used.

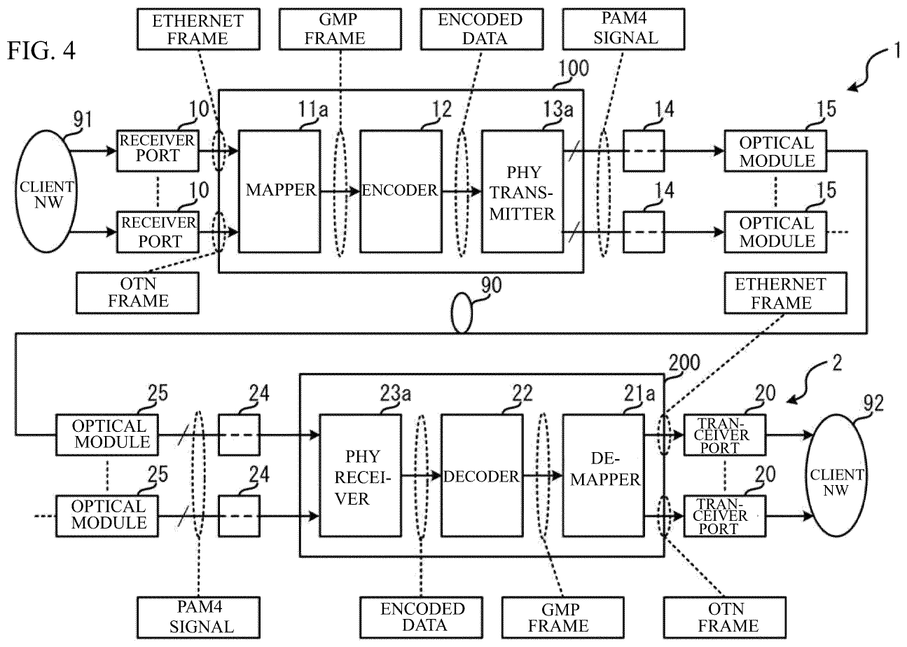

FIG. 4 is a configuration diagram of an example of a transmission system according to the second embodiment. In FIG. 4, components common to those in FIG. 1 are assigned the same reference numerals, and their description will be omitted.

The transmission processor 100 includes a mapper 11a, the encoder 12, and a PHY transmitter 13a. The mapper 11a maps client signals input from multiple receiver ports 10 into a GMP frame.

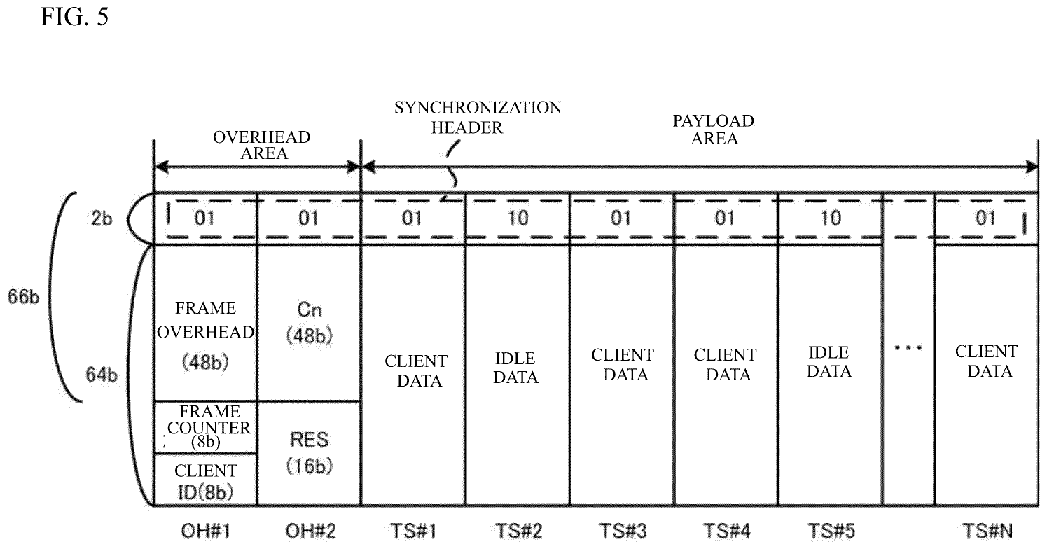

FIG. 5 is a diagram of an example of a GMP frame. The GMP frame is illustrated with a 2-bit synchronization header added using 64B/66B encoding by the encoder 12. The GMP frame includes an overhead area and a payload area. Excluding the synchronization header, the overhead area includes 64-bit blocks OH #1 and OH #2, and the payload area includes 64-bit blocks TS #1 to TS #N (N: a positive integer).

A block OH #1 includes a 48-bit frame overhead, an 8-bit frame counter, and an 8-bit client ID. The frame overhead is data of a predetermined pattern for establishing frame synchronization of the GMP frame. The frame counter is the GMP frame counter value (0 to 255 (decimal)). The client ID is the port number of the receiver port 10 from which the client signal is input.

A block OH #2 includes a 48-bit Cn and a 16-bit RES. Cn is an example of information for identifying the position of IDLE data within the GMP frame. Cn corresponds to Cn (t) specified in ITU-T Recommendation G.709, for example. RES is a reserved field.

$$Cn = int \{ ( Fclient / Fserver ) \times ( Bserver / n ) \} \qquad ( 1 )$$

The mapper 11a calculates Cn according to the above formula (1). In the formula (1), Fclient is the data rate of the client signal per GMP frame period calculated from the data volume (bits) of the client signal arriving within the GMP frame period. Fserver is the data rate of the area allocated to the client signal in the payload area of the GMP frame, which corresponds to the data rate of the Ethernet signal. Bserver is the data volume (bits) of the payload area allocated to the client signal. Note that int is a function that outputs an integer value.

For example, consider the case where the mapper 11a accommodates the client signal in ODU2e and multiplexes it into the GMP frame. In this case, Fclient is the data rate of ODU2e taking into account 64B/66B encoding, which is 10.7245 (=10.399×66/64) (Gbps). Furthermore, if the payload area of a GMP frame has 152 blocks, each 66 bits×16, then Fserver is 10.8463 (=0.67789×16) (Gbps) based on the data rate per block. Since 16 blocks are required to accommodate ODU2e, Bserver is 64 bits×16×16. n is, for example, 256 bits.

The payload area also includes blocks TS #1 to #N (N: positive integer). Blocks TS #1 to #N accommodate client signal data (client data) or IDLE data.

$$i \times Cn mod Pserver < Cn \qquad ( 2 )$$

$$i \times Cn mod Pserver \geq Cn \qquad ( 3 )$$

Based on the above formulas (2) and (3), the mapper 11a determines whether to store client data or IDLE data in the ith block TS #i (i: positive integer) from the beginning. In the formulas (2) and (3), Pserver is the maximum number of Nb bits of client data in the payload area. When Nb=256 bits and the number of blocks is 152, Pserver is 608 (=152×16×64/256).

If the formula (2) is satisfied, the mapper 11a stores client data in a block TS #i, and if the formula (3) is satisfied, the mapper 11a stores IDLE data in a block TS #i. In this way, the mapper 11a maps IDLE data to the GMP frame according to the difference between the data rate of the GMP frame and the transmission rate of the Ethernet signal. Therefore, the mapper 11a can convert the data rate of the GMP frame according to the transmission rate of the Ethernet signal transmitted by the optical module 15.

The mapper 11a assigns a client ID to the client signal for each of the receiver ports 10. For example, a client ID #1 is assigned to Ethernet frame received at one of the receiver ports 10, and a client ID #2 is assigned to OTN frame received at another of the receiver ports 10. The mapper 11a generates one or more GMP frames for each client ID. When a client signal is accommodated across multiple GMP frames, the mapper 11a generates a frame counter for each GMP frame so that the frame counters are consecutive for each client ID. Furthermore, the mapper 11a inserts Cn only into the first block OH #2 of the GMP frame with the smallest frame counter for each client ID, and sets all other GMP frame blocks OH #2 to RES.

For example, if the mapper 11a accommodates three client signals in three ODU2e frames #1 to #3, the data rate of each of the ODU2e frames #1 to #3 is 10.399 (Gbps), and therefore each of the ODU2e frames #1 to #3 is mapped to a block TS #i of 16 GMP frames. The client data accommodated in each block TS #i is indicated by the client ID in the frame counter of the GMP frame.

The frame counter of the GMP frame indicating the client IDs corresponding to the 16 blocks TS #i accommodating ODU2e frame #1 ranges from 0 to 15 (decimal). The frame counter of the GMP frame indicating the client IDs corresponding to the 16 blocks TS #i accommodating ODU2e frame #2 ranges from 16 to 31 (decimal). The frame counters of the GMP frames representing the client IDs corresponding to the 16 blocks TS #i that accommodate the ODU2e frame #3 range from 32 to 47 (decimal).

The client ID corresponding to the block TS #i of the 16 GMP frames accommodating ODU2e frame #1 is 1 (decimal). The client ID corresponding to the block TS #i of the 16 GMP frames accommodating ODU2e frame #2 is 2 (decimal). The client ID corresponding to the block TS #i of the 16 GMP frames accommodating ODU2e frame #3 is 3 (decimal). Cn is held only in the GMP frame with the smallest frame counter (0, 16, 32) for each client ID.

The mapper 11a notifies the encoder 12 of whether client data or IDLE data is accommodated for each block TS #i.

Based on the notification, the encoder 12 assigns a synchronization header “01” (binary) to the block TS #i containing client data and a synchronization header “10” (binary) to the block TS #i containing IDLE data. Therefore, as in the first embodiment, the receiver 2 can easily distinguish between IDLE data and client data based on the synchronization headers. The encoder 12 also assigns a synchronization header “01” (binary) to the blocks OH #1 and OH #2 in the overhead area.

As described above, the mapper 11a inserts into the GMP frame an overhead area containing Cn, which identifies the position of IDLE data within the GMP frame. Therefore, the receiver 2 can detect an error in the block TS #i by comparing the position of the IDLE data identified based on Cn with the value of the synchronization header for each block TS #i.

The PHY transmitter 13a has a physical layer PMA function. The PHY transmitter 13a PAM-modulates the encoded data generated by the encoder 12 encoding the GMP frame and converts it into multiple PAM4 signals. The PHY transmitter 13a outputs the multiple PAM4 signals in parallel from the SerDes circuit to the optical module 15. At this time, the PHY transmitter 13a adds an alignment marker (AM) to the encoded data so that skew between lanes is corrected. Note that the PHY transmitter 13a is an example of a signal outputter, and the PAM4 signals are an example of a data signal.

The reception processor 200 includes a demapper 21a, the decoder 22, and a PHY receiver 23a. The PHY receiver 23a has a physical layer PMA function. The PHY receiver 23a recovers encoded data from the PAM4 signal input from the optical module 25 and outputs the data to the decoder 22. The PHY receiver 23a corrects skew between lanes of the PAM4 signal based on the AM.

The decoder 22 recovers GMP frame by decoding the encoded data. The decoder 22 notifies the demapper 21a of a synchronization header for each 64-bit block.

The demapper 21a demaps multiple client signals from the GMP frame. The demapper 21a establishes frame synchronization of the GMP frame by detecting frame overhead, and recovers client signals based on the client ID and Cn of the GMP frame. The demapper 21a identifies the client data and the IDLE data based on Cn.

The demapper 21a also verifies the identification result of the client data and the IDLE data based on the value of the synchronization header. The demapper 21a detects an error if the identification results of the client data and the IDLE data based on the synchronization header and Cn do not match.

Next, the operation of the transmission processor 100 and the reception processor 200 will be described.

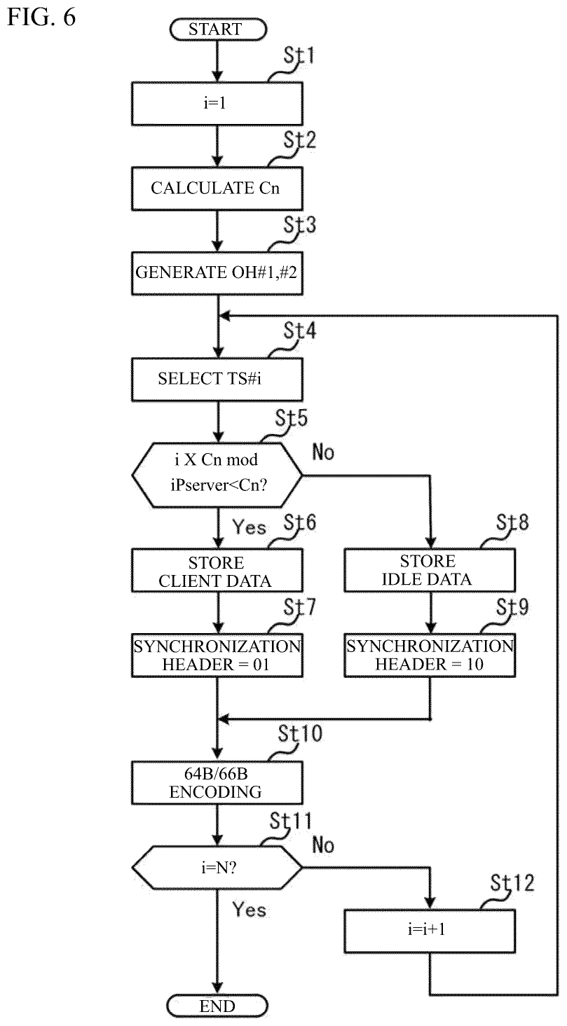

FIG. 6 is a flowchart of an example of the operation of the transmission processor 100. This operation is performed each time a GMP frame is generated. Note that the operation of the PHY transmitter 13a is omitted in FIG. 6.

First, the mapper 11a sets the variable i to 1 (step St1). The variable i indicates the position of the block TS #i in the payload area of the GMP frame.

Next, the mapper 11a calculates Cn using the above formula (1) based on the preset data rates of the client signal and the GMP frame (step St2). Next, the mapper 11a generates the blocks OH #1 and OH #2 in the overhead area (step St3). At this time, the mapper 11a inserts a client ID corresponding to the receiver port 10 of the client signal into the block OH #1 and inserts Cn into the block OH #2.

Next, the mapper 11a selects the block TS #i in the payload area that accommodates the client signal (step St4). Next, the mapper 11a determines whether the above formulas (2) and (3) are satisfied (step St5).

If the formula (2) is satisfied (Yes in step St5), the mapper 11a stores the client data in the block TS #i (step St6). Next, the encoder 12 generates a synchronization header “01” (binary) corresponding to the client data (step St7).

Furthermore, if the formula (3) is satisfied (No in step St5), the mapper 11a stores IDLE data in the block TS #i (step St8). Next, the encoder 12 generates a synchronization header “10” (binary) corresponding to the IDLE data (step St9).

Next, the encoder 12 performs 64B/66B encoding (step St10). At this time, the encoder 12 scrambles the 64-bit block TS #i and adds a 2-bit synchronization header.

Next, the mapper 11a compares the variable i with a predetermined value N (step St11). Here, the predetermined value N is the maximum number of the blocks TS #i in the payload area. If i≠N is satisfied (No in step St11), the mapper 11a adds 1 to the variable i (step St12). Thereafter, the operations from step St4 onwards are executed again.

Also, if i=N is satisfied (Yes in step St11), client data or IDLE data has been stored in all blocks TS #1 to #N of the payload area, and this operation ends. The transmission processor 100 operates in this manner.

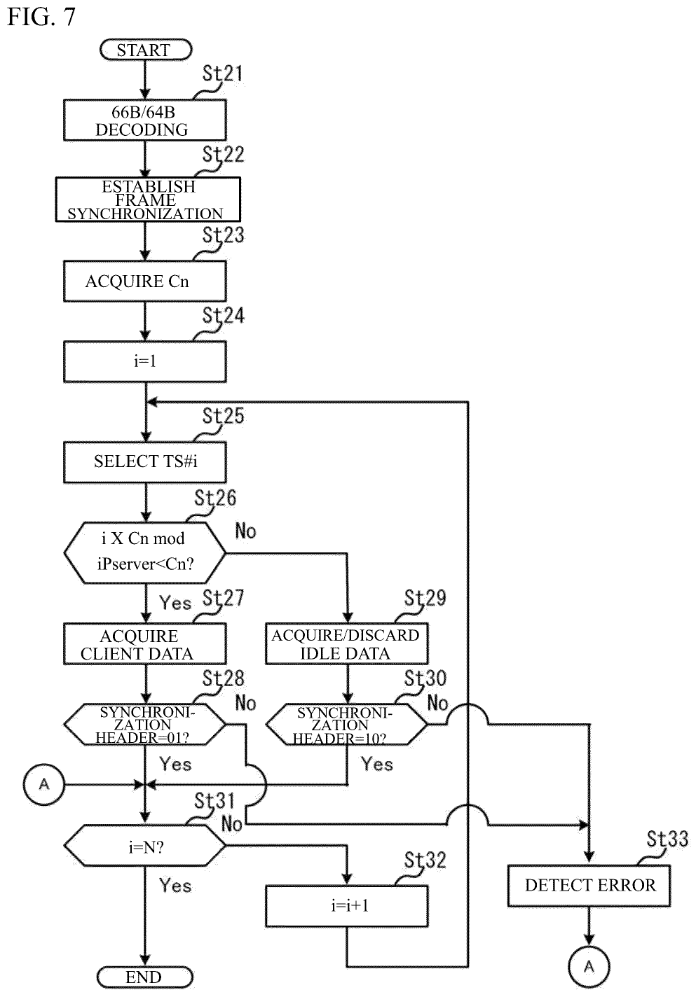

FIG. 7 is a flowchart of an example of the operation of the reception processor 200. Note that the operation of the PHY receiver 23a is omitted in FIG. 7.

First, the decoder 22 decodes the encoded data (step St21). Next, the demapper 21a detects the frame overhead in the overhead area from the decoded data to establish GMP frame synchronization (step St22).

Next, the demapper 21a acquires Cn from the overhead area (step St23). Next, the demapper 21a sets the variable i to 1 (step St24). Next, the demapper 21a selects the block TS #i in the payload area (step St25).

Next, the demapper 21a determines whether the above formulas (2) and (3) are satisfied (step St26). If the formula (2) is satisfied (Yes in step St26), the demapper 21a acquires client data from the selected block TS #i (step St27). Next, the demapper 21a determines whether the value of the synchronization header corresponding to the currently selected block TS #i is “01” (binary) (step St28).

If the value of the synchronization header is not “01” (binary) (No in step St28), the demapper 21a detects an error (step St33). The operation of step St31, described below, is then performed.

If the value of the synchronization header is “01” (binary) (Yes in step St28), the demapper 21a compares the variable i with a predetermined value N (step St31). If i #Nis satisfied (No in step St31), the demapper 21a adds 1 to the variable i (step St32). Then, the operations from step St25 onward are performed again. Also, if i=N is satisfied (Yes in step St31), this operation ends because client data or IDLE data has been acquired from all blocks TS #1 to #N in the payload area

Furthermore, if the formula (3) is satisfied (No in step St26), the demapper 21a acquires and discards IDLE data from the currently selected block TS #i (step St29). Next, the demapper 21a determines whether the value of the synchronization header corresponding to the currently selected block TS #i is “10” (binary) (step St30).

If the value of the synchronization header is not “10” (binary) (No in step St30), the demapper 21a detects an error (step St33). Then, the operation of step St31 is performed. If the value of the synchronization header is “10” (binary) (Yes in step St30), the operation of step St31 is performed. In this manner, the operation of the reception processor 200 is performed.

As described above, the transmission system of this example transmits client signals accommodated in GMP frames, thereby improving bandwidth utilization efficiency compared to the case where the client signals are packetized by a circuit emulator and transmitted. According to the results of simulations conducted by the inventors, the bandwidth utilization efficiency achieved by the circuit emulator was only 94.3%, whereas the bandwidth utilization efficiency achieved by this example was 98.8% or more.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention.

What is claimed is:

1. A signal processing device connected to an optical transmitter that transmits an Ethernet signal by optical modulation based on a data signal, comprising:
a mapper unit configured to map a plurality of client signals into a frame signal;
an encoder configured to encode the frame signal to generate blocks of a number of bits corresponding to the Ethernet signal; and
a signal outputter configured to generate the data signal from the blocks and outputs the data signal to the optical transmitter.

2. The signal processing device as claimed in claim 1,
wherein the mapper adds dummy data to the frame signal in accordance with a difference between a data rate of the frame signal and a transmission rate of the Ethernet signal.

3. The signal processing device as claimed in claim 2,
wherein the blocks include a synchronous header for identifying the dummy data and the frame signal, respectively.

4. The signal processing device as claimed in claim 1,
wherein the mapper adjusts a data rate of the frame signal in accordance with a transmission rate of the Ethernet signal.

5. The signal processing device as claimed in claim 1,
wherein the mapper maps dummy data to the frame signal in accordance with a difference between a data rate of the frame signal and a transmission rate of the Ethernet signal.

6. The signal processing device as claimed in claim 5,
wherein the blocks include a synchronization header for identifying the dummy data and the client signal, respectively.

7. The signal processing device as claimed in claim 5,
wherein the mapper inserts an overhead into the frame signal, the overhead including information for identifying a position of the dummy data within the frame signal.

8. A signal processing device connected to an optical receiver that receives an optically modulated Ethernet signal based on a data signal encoded into blocks of a predetermined number of bits, comprising:
a decoder configured to decode the data signal output by the optical receiver; and
a demapper configured to demap a plurality of client signals from the frame signal obtained by decoding the data signal.

9. A signal processing method for a data signal input to an optical transmitter that transmits an Ethernet signal by optical modulation based on the data signal, the method comprising:
mapping a plurality of client signals into a common frame signal;
encoding the frame signal to generate blocks of each bit number corresponding to the Ethernet signal; and
generating the data signal from the blocks.

10. The signal processing method as claimed in claim 9,
wherein, in the mapping, a dummy data is added to the frame signal in accordance with a difference between a data rate of the frame signal and a transmission rate of the Ethernet signal.

11. The signal processing method as claimed in claim 10,
wherein the blocks include a synchronous header for identifying the dummy data and the frame signal, respectively.

12. The signal processing method as claimed in claim 9,
wherein, in the mapping, a data rate of the frame signal is adjusted according to a transmission rate of the Ethernet signal.

13. The signal processing method as claimed in claim 9,
wherein, in the mapping, a dummy data is mapped to the frame signal in accordance with a difference between a data rate of the frame signal and a transmission rate of the Ethernet signal.

14. The signal processing method as claimed in claim 13,
wherein the blocks include a synchronization header for identifying the dummy data and the client signal, respectively.

15. The signal processing method as claimed in claim 13,
wherein, in the mapping, an overhead is inserted into the frame signal, the overhead including information for identifying a position of the dummy data within the frame signal.

16. A signal processing method comprising:
receiving an optically modulated Ethernet signal based on a data signal encoded into blocks of a predetermined number of bits, by an optical receiver;
decoding the data signal output from the optical receiver; and
demapping a plurality of client signals from a frame signal decoded from the data signal.
